(19) United States
(12) Patent Application Publication
(10) Pub. No.: US 2016/0193863 A1
(43) Pub. Date: Jul. 7, 2016

(54) GREETING CARD SYSTEM

(71) Applicant: Joseph Wells, Tempe, AZ (US)

(72) Inventor: Joseph Wells, Tempe, AZ (US)

(21) Appl. No.: 14/591,915

(22) Filed: Jan. 7, 2015

(51) Int. Cl. B42D 15/04

(52) U.S. Cl. CPC B42D 15/045

(57) ABSTRACT

A greeting card includes a pocket disposed on an interior of the card, the pocket including at least one pocket flap to allow access to the pocket; and a functional indicia disposed on the interior of the open greeting card, the functional indicia to present the open greeting card as an additional gift or to supplement the additional gift. The gift be could any item that fits in the pocket, such as, for example, money, a gift card, a ring, etc. The pocket can assume various shapes such as a square, a circle, an oval, a star, a face, a rectangle, etc. The pocket flap can include one or more flaps allowing the pocket to be open or closed. In various embodiments, a foam panel is used to provide thickness to the pocket.

### BACKGROUND OF THE INVENTION

1. Field of the Invention

The present invention relates to a greeting card system.

2. Description of the Related Art

Greeting cards are an important part of providing or supplementing a gift, especially during a holiday or a significant event, such as during Christmas or a birthday. Greeting cards may be provided with supplemental features as well, such as ornamental or structural features. Structural features such as a microchip to play recorded sounds can be expensive to manufacture. It would be desirable to have an improved greeting card system with relatively inexpensive supplemental features that enhance remembrance of the ocassion.

### SUMMARY OF THE INVENTION

A greeting card includes a pocket disposed on an interior of the card, the pocket including at least one pocket flap to allow access to the pocket; and a functional indicia disposed on the interior of the open greeting card, the functional indicia to present the open greeting card as an additional gift or to supplement the additional gift. The gift can be any item that fits in the pocket, such as, for example, money, a gift card, a ring, etc. The pocket can assume various shapes such as a square, a circle, an oval, a star, a face, a rectangle, etc. The pocket flap can include one or more flaps allowing the pocket to be open or closed. In various embodiments, a foam panel is used to provide depth of the pocket. The foam panel includes a hole corresponding to the shape of the pocket.

The greeting card further comprises a plurality of panels, such as a first panel, a second panel, a third panel and a fourth panel. In an embodiment, the fourth panel is folded over the third panel and the third panel is folded over the second panel. In an alternate embodiment, the fourth panel is folded under the third panel and the third panel is folded over the second panel. A suitable adhesive may be used to secure panels and/or foam together.

In an embodiment, the pocket further includes a plurality of ribbon holes disposed on the pocket flaps. The ribbon holes accommodate a ribbon to be extended through each of the ribbon holes to be tied into a bow. In other embodiments, the pocket may be closed by using a suitable button, a sticker, a hook-and-loop fastener, a zipper, a snap, magnets, a string, etc.

### BRIEF DESCRIPTION OF THE DRAWINGS

FIG. 1 illustrates a greeting card, according to an embodiment of the invention;

FIG. 2 illustrates the greeting card open and revealing an exemplary pocket;

FIG. 3 illustrates a close-up view of the pocket;

FIG. 4 illustrates the greeting card open and revealing the pocket having a gift disposed therein;

FIG. 5 illustrates the pocket secured with a ribbon and bow;

FIG. 6 illustrates the greeting card open and revealing another exemplary pocket; and

FIGS. 7-16 illustrate methods of manufacture of the greeting card, according to various embodiments.

### DETAILED DESCRIPTION OF THE INVENTION

FIG. 1 illustrates a greeting card 100. As depicted, the greeting card 100 is a birthday card but it is to be understood that the greeting card 100 could be a greeting card for another occasion, such as an anniversary, a graduation, a holiday, etc. When the greeting card 100 is closed, as illustrated in FIG. 1, it looks like a conventional greeting card.

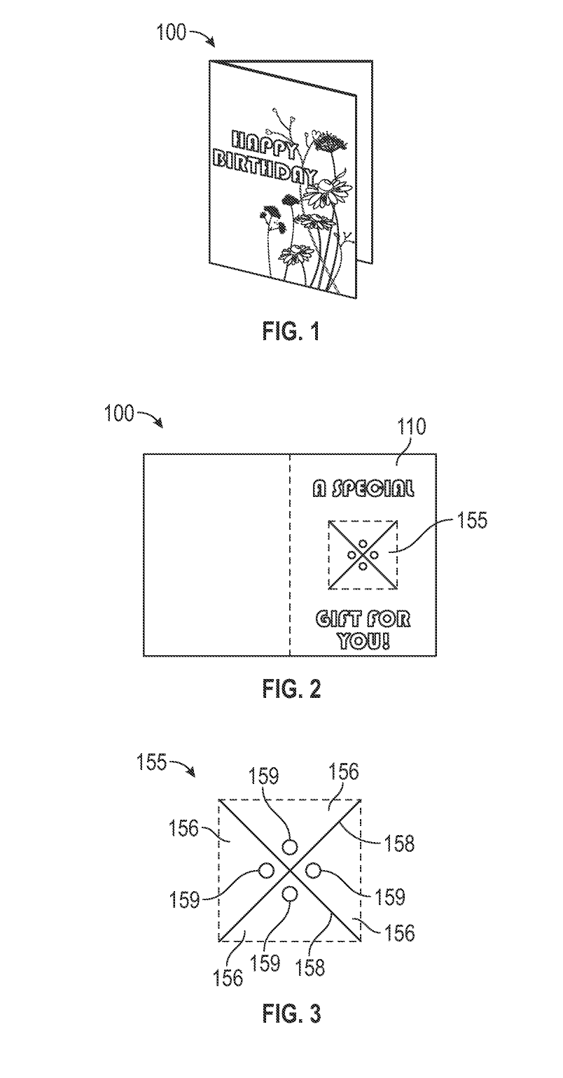

FIG. 2 illustrates the greeting card 100 as it appears when opened. As can be seen, a pocket 155 is thereupon revealed, according to an embodiment of the present invention. The pocket 155 is disposed in an interior 110 of the greeting card 100. As shown, the pocket 155 is closd. FIG. 3 illustrates a close-up view of the pocket 155. The pocket 155 includes a pair of crossed slots 158 that are cuts through the card stock forming a plurality of pocket flaps 156. The pocket flaps 156 can be pulled back to open the pocket 155. In an embodiment, each pocket flap 156 includes a ribbon hole 159. As will be described, a ribbon can be threaded through the ribbon holes 159 to secure the pocket flaps 156. In other embodiments, the pocket 155 may be closed by using a suitable button, a sticker, a hook-and-loop fastener, a zipper, a snap, magnets, a string, etc.

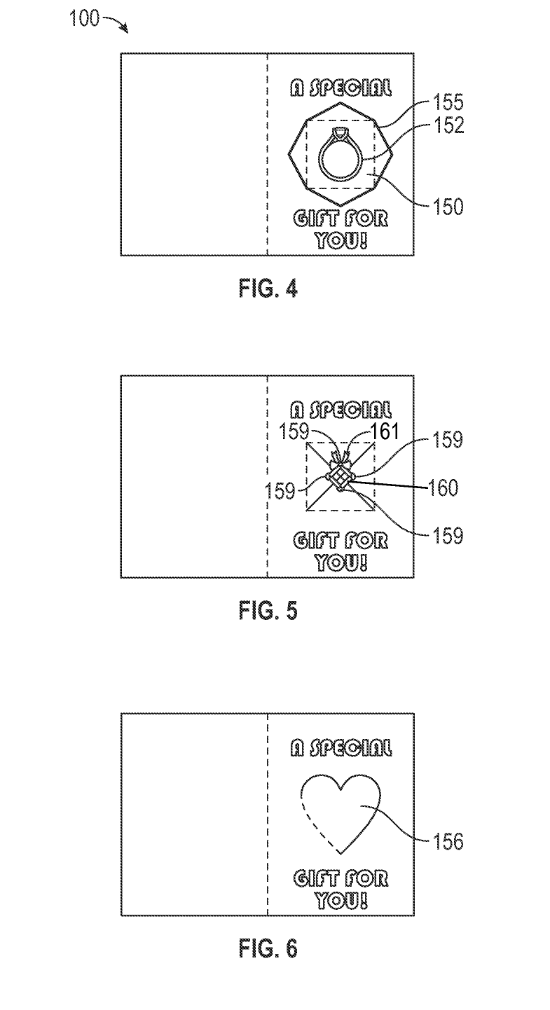

FIG. 4 illustrates the pocket 155 open and revealing a gift 152 inside. In this case, the gift 152 is a ring, but the gift could be any object capable of fitting into the pocket 155. The gift 152 may be placed in an interior 158 of the pocket 155 by the person giving the card. Alternatively, the gift 152 may be placed in the interior 158 during fabrication. In the illustrated embodiment, functional indicia are disposed on the greeting card 100. As shown, the functional indicia include the words “A special gift for you”. However, it is to be understood that other phrases, words, illustrations, etc., may be used. A primary purpose of the functional indicia 157 can be to present the gift 152.

FIG. 5 illustrates the pocket 155 of the greeting card 100 secured with a ribbon 160. As mentioned, the ribbon 160 may be threaded through the ribbon holes 159. The ribbon holes 159 may accommodate the ribbon 160 to be extended through each of the ribbon holes 159 and tied into a bow 161. The ribbon holes 159 may be disposed in a diamond orientation or the like, as shown.

FIG. 6 illustrates the greeting card 100 with a pocket flap 156 having a another shape, according to an embodiment of the invention. More particularly, the pocket flap 156 illustrated in FIG. 6 is heart-shaped. It is to be understood that the shape of the corresponding pocket 155 (not shown) would also be heart-shaped. It is to be understood further that the pocket 155 and flap 156 could assume various other shapes than those illustrated herein, such as a square, a circle, an oval, a star, a face, a rectangle, etc., without departing from the scope and spirit of the present invention.

Manufacture of the Greeting Card

It is to be understood that the methods of manufacture of the greeting card 100 described herein are not meant to be limiting. In an embodiment, a card stock is provided for printing, preferably glossy or semi-glossy paper on at least one side. As will be described in greater detail, the card stock is divided into a plurality of panels. Each panel will can be about the same size, e.g., 4″×5″. Thus, a 4-panel card stock would be about 16″ in length and 5″ in height.

After appropriately printing both sides of the card stock, the pocket 155 can be formed. Depending on the desired shape of the pocket 155, the pocket 155 can be formed by cutting into the card stock to form the pocket 155. For example, in the embodiment illustrated in FIGS. 2-6, the crossed slots 158 comprise a pair of linear cuts through the card stock. The crossed slots 158 are made at about a right angle (forming an “X” shape). Additionally, the ribbon holes 159 can be formed by punching the holes using a suitable machine or by hand, for example.

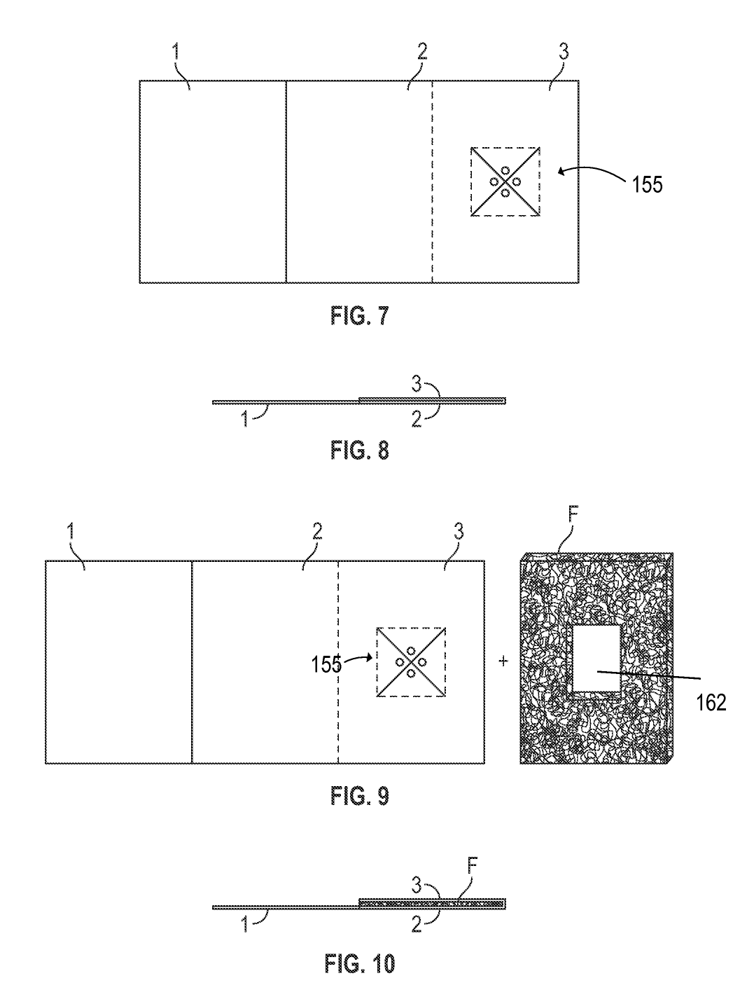

FIGS. 7-11 relate to various methods of completing the manufacture of a greeting card having three panels.

FIG. 7 illustrates the card stock including panels 1-3 prior for folding. As depicted, panel 3 includes the pocket 155. It is to be understood that the opposite side of panel 1 would be printed with an appropriate greeting such as is shown in FIG. 1, for example. Additionally, the functional indicia mentioned previously (e.g., “A Special Gift For You”) can be printed on the opposite side of panel 3. FIG. 8 illustrates a way to fold the panels 1-3. It is to be understood than an adhesive can be used to secure panels 2 and 3 together.

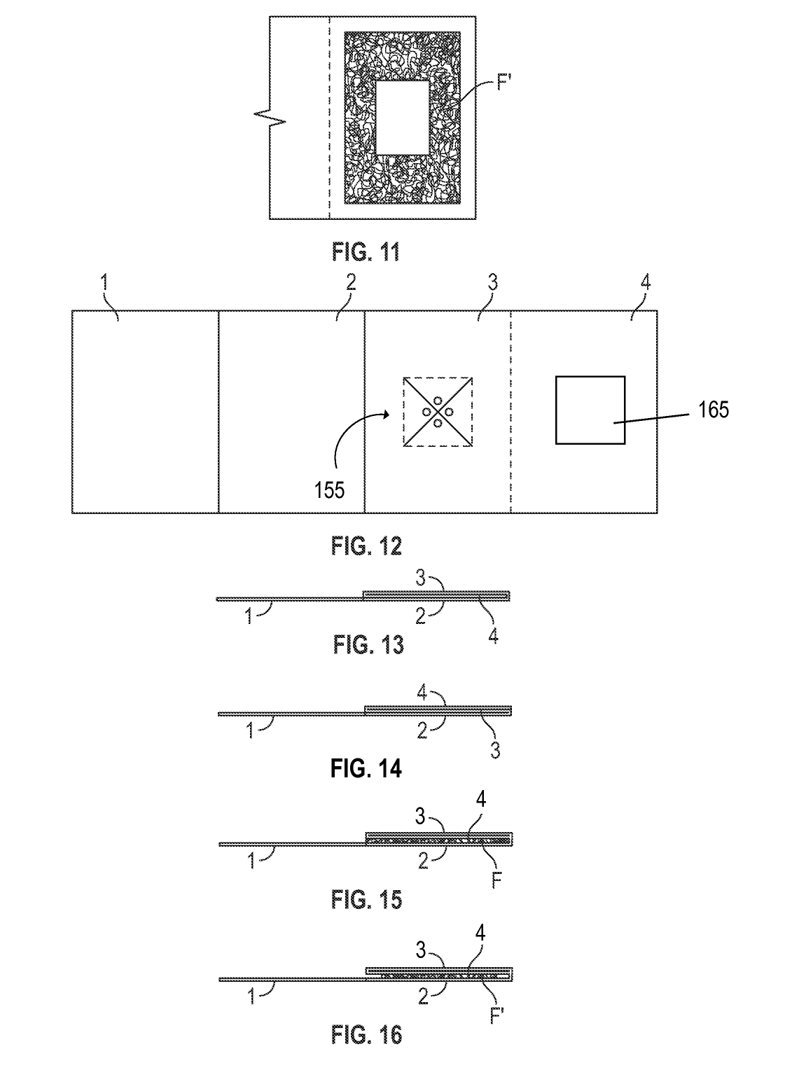

Referring to FIG. 9, to increase the depth of the pocket 155, a substantially planar piece of foam F can inserted between panels 2 and 3. The foam used can be polyurethane foam, for example. The foam F has a hole 162 corresponding to the pocket 155, which in the illustrated case is rectangular and having approximately the same width and length as the pocket 155. In this embodiment, the width/length of the foam F about the same or slightly less than that of each of the panels 1-3, e.g. 4″×5″. FIG. 10 illustrates a way to fold the panels 1-3 with the foam F sandwiched therein. FIG. 11, shows an embodiment where a piece of foam F′ is used instead of foam F, wherein F′ has substantially reduced size, e.g., 3″×4″ for a panel size of 4″×5″. It is to be understood that where a foam insert is employed, the adhesive would be used secure the panels 2,3 and the foam F (or F′) together.

FIG. 12 illustrates a 4-panel greeting card 100. As can be seen, the pocket 155 is disposed in the panel 3 and a hole 165 corresponding to the pocket 155 is disposed in the panel 4. FIG. 13 shows a ways to fold the panels 1-4, according to an embodiment. FIG. 14 illustrates an alternate way of folding the panels 1-4, according to another embodiment. If the panels 1-4 are folded this way, the packet would preferably instead be disposed in panel 4 and the hole 165 in panel 3.

FIGS. 15 and 16 show the greeting card 100 assembled using a foam insert. In particular, FIG. 15 shows the use of the foam F. FIG. 16 shows the use of reduced size foam F′.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A greeting card, comprising:
a pocket disposed on an interior of the greeting card, the pocket including at least one pocket flap allow access to the pocket; and
a functional indicia disposed on the interior of the open greeting card, the functional indicia to present the open greeting card as an additional gift or to supplement the additional gift.

2. The greeting card according to claim 1, further comprising a plurality of panels having a first panel, a second panel, a third panel and a fourth panel.

3. The greeting card according to claim 2, wherein the fourth panel is folded over the third panel and the third panel is folded over the second panel.

4. The greeting card according to claim 2, wherein the fourth panel is folded under the third panel and the third panel is folded over the second panel.

5. The greeting card according to claim 4, wherein foam is positioned between the second panel and the third panel.

6. The greeting card according to claim 1, further comprising a plurality of ribbon holes disposed on the pocket flaps.

7. The greeting card according to claim 6, wherein the ribbon holes accommodate a ribbon to be extended through each of the ribbon holes to be tied into a bow.

8. The greeting card according to claim 7, wherein the ribbon holes are disposed in a diamond orientation.

9. The greeting card according to claim 1, further comprising a plurality of pocket cuts that cut the pocket from corner to corner.

10. The greeting card system according to claim 9, wherein the ribbon holes are disposed on each of the pocket flaps and accommodate the ribbon to be extended through each of the ribbon holes and tied into the bow.

11. The greeting card system according to claim 10, wherein the pocket is heart-shaped.

12. The greeting card system according to claim 1, wherein the greeting card system is one of a birthday card, a holiday card, and an anniversary card.

13. The greeting card according to claim 1, wherein the greeting card is a holiday card.

14. A method for manufacturing a greeting card, comprising the steps of:
providing a card stock,
printing on a first facing and then printing on a second facing opposite the first facing;
cutting the card to form pocket flaps;
folding the card and threading a plurality of ribbon holes disposed on the card; and
tying a bow on the greeting card system.

15. The method according to claim 14, wherein the cutting step includes cutting the card to form the pocket flaps.

16. The method according to claim 14, wherein the folding and threading step includes threading a ribbon through the ribbon holes.

17. The method according to claim 14, wherein the tying step includes tying a bow after the ribbon has been threaded through the ribbon holes.
